(19) United States
(12) Patent Application Publication
(10) Pub. No.: US 2009/0178906 A1
(43) Pub. Date: Jul. 16, 2009

(54) KEYPAD PANEL ASSEMBLY HAVING ARRAYS OF MICROPORES

(76) Inventors: Chang-Li LIU, Taoyuan (TW); Che-Tung Wu, Taoyuan (TW)

Correspondence Address: HDLS Patent & Trademark Services, P.O. BOX 220746, CHANTILLY, VA, 20153-0746, US

(21) Appl. No.: 12/036,545

(22) Filed: Feb. 25, 2008

(30) Foreign Application Priority Data
Jan. 10, 2008 (TW) 097200636

(51) Int. Cl. H01H 9/00

(52) U.S. Cl. 200/310

(57) ABSTRACT

A keypad panel assembly having arrays of micropores includes a panel body, a shielding layer, a backlight module, and a telecommunication module. The panel body is formed into a plate. The shielding layer is provided on one surface of the panel body. A plurality of micropores are formed on the shielding layer. The micropores are arranged to form patterns for pressing. The backlight module is arranged on one surface of the shielding layer. The telecommunication module is arranged on one surface of the backlight module. When a set of light-emitting units is lighted up, the light enters one end of a light-guiding plate. The light is reflected by light-guiding microstructures onto the corresponding key, so that the user can see the position of each key clearly.

### RELATED APPLICATIONS

U.S. patent applications Ser. No. 12/014,857 filed on Jan. 16, 2008, Ser. No. 11/957,771 filed on Dec. 17, 2007 are submitted as related applications.

### BACKGROUND OF THE INVENTION

1. Field of the Invention

The present invention relates to a keypad panel, and in particular to a keypad panel assembly.

2. Description of Prior Art

With the continuous progress of communication technologies, many electronic products are manufactured to a more compact extent so as to reduce the size and weight of the electronic product. Thus, it is convenient for a user to carry about such a compact electronic product. In order to reduce the size and weight of the electronic product, not only the volume of the internal integrated circuit is reduced, but also the area and thickness of a keyboard on an operating interface of the electronic product should be reduced. As a result, the electronic product can be mounted on a communication device easily.

As shown in FIGS. 1(a) and 1(b), US Patent publication No. 2007/0205986A1 discloses a current keypad panel. The disclosed metallic keypad panel 10a has an elastic layer 1a. One surface of the elastic layer 1a has thereon a plurality of protrusions 11a. The other surface of the elastic layer 1a is arranged with a plurality of metallic keys 2a to correspond to the protrusions 11a. The metallic key 2a has a hollowed portion 21a with a corresponding pattern. A light-transmitting resin layer 22a is filled in the hollowed portion 21a. When the metallic keypad panel 10a is disposed in a base 20a of an electronic device, the metallic keypad panel 10a is located on a telecommunication module 30a. The telecommunication module 30a has a printed circuit board 31a. The circuit board 31a has a plurality of immovable contacting points 32a. A metallic sheet 33a is disposed on the circuit board 31a. The metallic sheet 33a has thereon a plurality of convex metal domes 331a. Each metal dome 331a corresponds to each contacting point 32a, and the other surface of each metal dome 331a corresponds to each protrusion 11a. When the metallic key 2a is pressed, the protrusion 11a is caused to press the surface of the metal dome 331a, so that the metal dome 331a is deformed and brought into contact with the contacting point 32a, thereby generating an electronic signal output. Further, when a backlight source is lighted up, the light of the backlight source can pass through the resin layer 22a of the metallic key 2a, so that the user can see the position of each key clearly.

Although the above-mentioned metallic keypad panel 10a has been manufactured to a compact extent and can be mounted in a small-volume electronic device, during the manufacturing process, it is necessary to fill the individual hollowed portions 21a on the metallic key 2a with the resin layer 22a, and each of the metallic keys 2a has to be adhered onto one surface of the elastic layer la accurately. As a result, the manufacturing process takes a lot of time and labors and is not simple. After the metallic keypad panel 10a is combined with the base 20a, a gap is formed between the periphery of the metallic key 2a and the base 20a, and the gap may be filled by external dusts or penetrated by moisture easily. As a result, the metallic key cannot be pressed smoothly or an internal short circuit may occur. Further, when the backlight source of the keypad panel 10a is lighted up, the hollowed portion 21a of the key 2a merely displays single luster. Therefore, the external appearance and the overall visual effect of the metallic keypad panel are dull.

### SUMMARY OF THE INVENTION

In view of the above drawbacks, the present invention is to provide a keypad panel that is simple in structure and can be manufactured easily. Therefore, the pattern on the keypad panel can be displayed more clearly. Also, the keypad panel can be protected against the accumulation of dusts and the penetration of moisture.

The present invention is to provide a keypad panel assembly having arrays of micropores, which includes a panel body, a shielding layer, a backlight module, and a telecommunication module. The panel body is made of a plastic material such as any one of a PC film or TPU film. The shielding layer is provided on one surface of the panel body. A plurality of micropores are formed on the shielding layer. The micropores are arranged to form patterns for pressing. The backlight module has a light-guiding plate. The light-guiding plate has a plurality of light-guiding microstructures. The light-guiding microstructures are recessed in or protrude from one surface of the light-guiding plate. Further, a set of light-emitting units is arranged on one end of the light-guiding plate. The set of light-emitting units is constituted of a plurality of light-emitting diodes having the same or different colors. A sheet-like shielding unit is arranged above the set of light-emitting units and the light-guiding plate. The telecommunication module has a flexible printed circuit board. The circuit board is provided thereon with a plurality of contacting points. Each contacting point corresponds to a metal dome. A film layer is arranged on one surface of the circuit board and the metal dome. A protrusion is provided on the protruding surface of the film layer. The protrusion corresponds to the light-guiding microstructures of the light-guiding plate.

### BRIEF DESCRIPTION OF THE DRAWINGS

FIGS. 1(a) and 1(b) are schematic views showing a conventional metallic keypad panel;

FIG. 2 is an exploded view showing the keypad panel and the backlight module of the present invention;

FIG. 3 is a top view showing the keypad panel and the backlight module of the present invention;

FIG. 4 is an assembled cross-sectional view showing the keypad panel and the backlight module of the present invention;

FIG. 5(a) is an assembled side view showing the keypad panel, the backlight module and the telecommunication module of the present invention;

FIG. 5(b) is a schematic view showing a pressing action showing the keypad panel, the backlight module and the telecommunication module of the present invention;

FIG. 6 is an assembled side view showing the keypad panel, the backlight module and another telecommunication module of the present invention;

FIG. 7 is a schematic view showing the keypad panel of the present invention being used in a mobile phone;

FIG. 8 is a schematic view showing the keypad panel of the present invention being used in a personal digital assistant; and

FIG. 9 is a schematic view showing the keypad panel of the present invention being used in an automobile stereo panel.

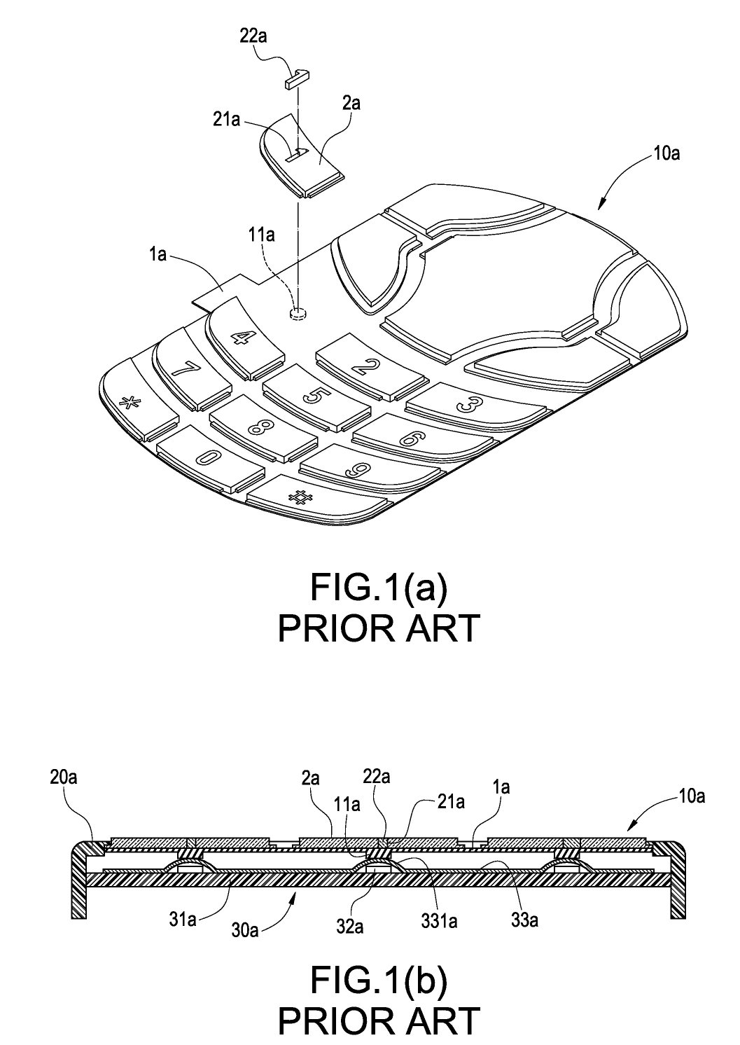

### DETAILED DESCRIPTION OF THE INVENTION

The detailed description and technical contents of the present invention will be explained with reference to the accompanying drawings.

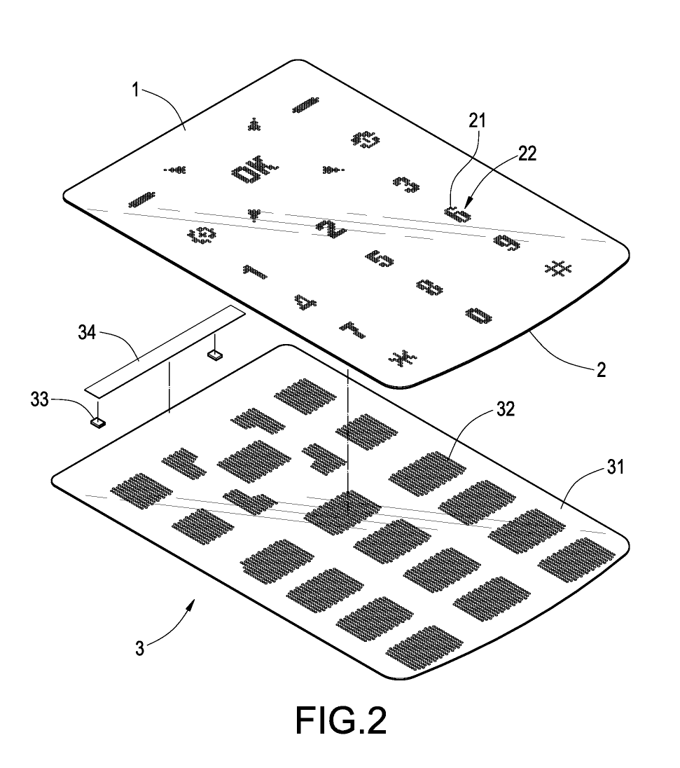

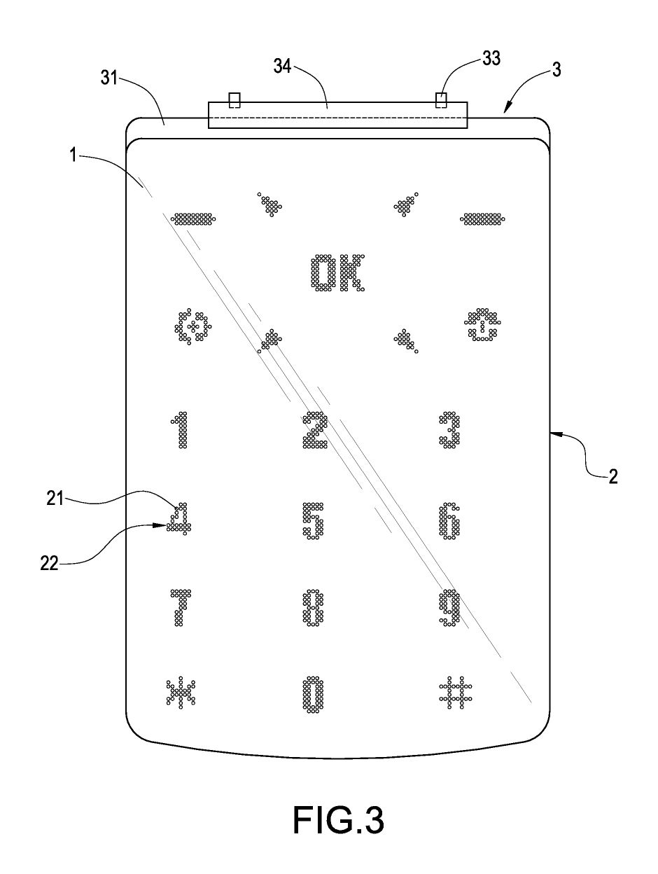

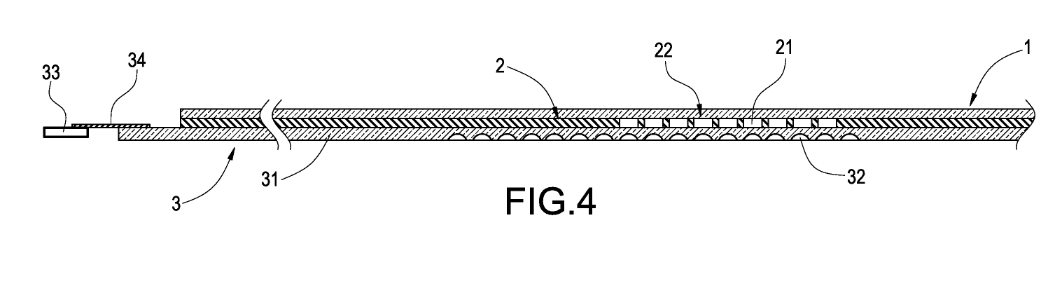

FIG. 2 is an exploded view showing the keypad panel and the backlight module of the present invention. FIG. 3 is a top view showing the keypad panel and the backlight module of the present invention. FIG. 4 is an assembled cross-sectional view showing the keypad panel and the backlight module of the present invention. As shown in these figures, the present invention provides a keypad panel assembly having arrays of micropores, which includes a panel body 1, a shielding layer 2, a backlight module 3, and a telecommunication module 4.

The panel body 1 is made of a plastic material such as any one of a PC film or TPU film, and can be made transparent, translucent or opaque.

The shielding layer 2 is provided on one surface of the panel body 1. A plurality of micropores 21 is formed on the shielding layer 2. The micropores 21 are arranged to form patterns 22 for pressing. The above-mentioned patterns 22 are any of numerals, characters, specific symbols (“#”, “*”, “.”) and direction symbols. The shielding layer 2 is made of any one of inks, Al, Ni, Ti or Ag.

The backlight module 3 has a light-guiding plate 31. The light-guiding plate 31 has a plurality of light-guiding microstructures 32 thereon. The light-guiding microstructures 32 are recessed in or protrude from one surface of the light-guiding plate 31. Further, a set of light-emitting units 33 is arranged on one end of the light-guiding plate 31. The set of light-emitting units 33 is constituted of a plurality of light-emitting diodes having the same or different colors. A sheet-like shielding unit 34 is arranged above the set of light-emitting units 33 and the light-guiding plate 31, thereby avoiding the interference of light generated by the set of light-emitting units 33.

The telecommunication module 4 has a flexible printed circuit board (FPCB) 41. The circuit board 41 is provided thereon with a plurality of contacting points 411. Each contacting point 411 corresponds to a metal dome 42. A film layer 43 is disposed on one surface of the circuit board 41 and the metal dome 42. The protruding surface of the film layer 43 is provided with a protrusion 44. The protrusion 44 corresponds to the light-guiding microstructures 32 of the light-guiding plate 31.

Please refer to FIG. 4, which is a side cross-sectional view of the keypad panel of the present invention. As shown in this figure, when the set of light-emitting units 33 is lighted up, the light 5 generated by the set of light-emitting units 33 enters the light-guiding plate 31. Then, the light 5 is refracted by the light-guiding microstructures 32 onto the corresponding pattern 22 of the shielding layer 2. The light 5 passes through the plurality of micropores 11, so that the surface of the panel body 1 displays a backlight of a luster.

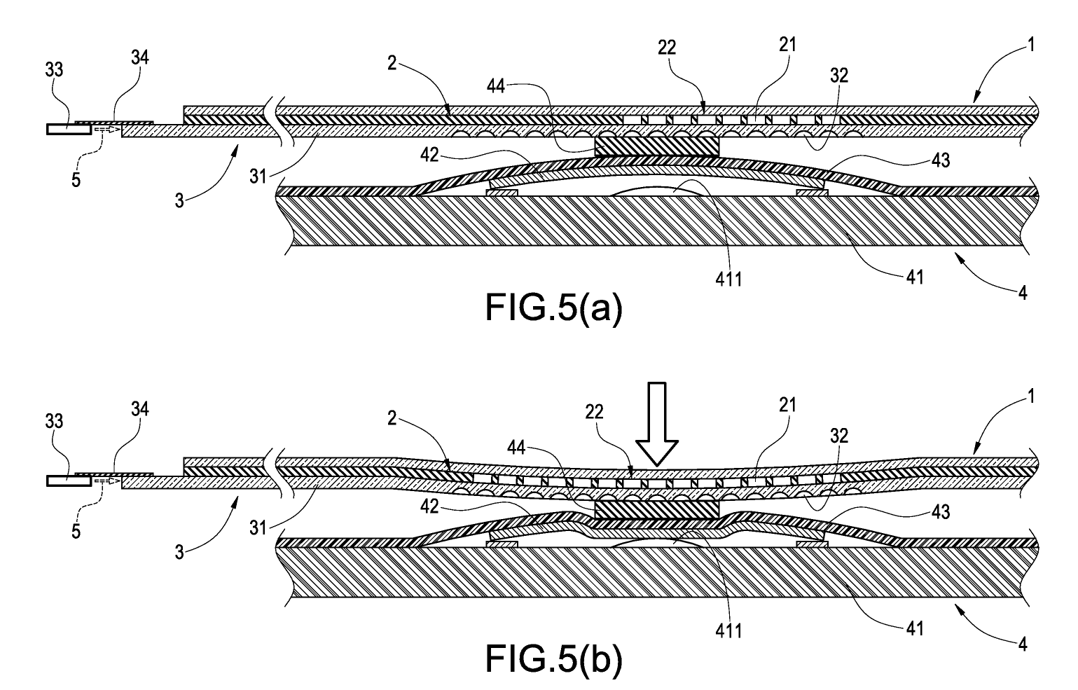

Please refer to FIGS. 5(a) and 5(b). FIG. 5(a) is an assembled side view showing the keypad panel, the backlight module and the telecommunication module of the present invention, and FIG. 5(b) is a schematic view showing a pressing action of the present invention. When the surface of the panel body 1 is pressed by an external force, the surface of the panel body 1, the shielding layer 2 and the backlight module 3 are deformed to cause the protrusion 44 to press the film layer 43. As a result, the metal dome 42 is deformed and pressed to contact with the contacting point 411, thereby generating a conductive signal output.

When one surface of the panel body 1 is not pressed by an external force, due to the elasticity of the panel body 1 and the metal dome 42, the panel body 1 may rise automatically to its original state.

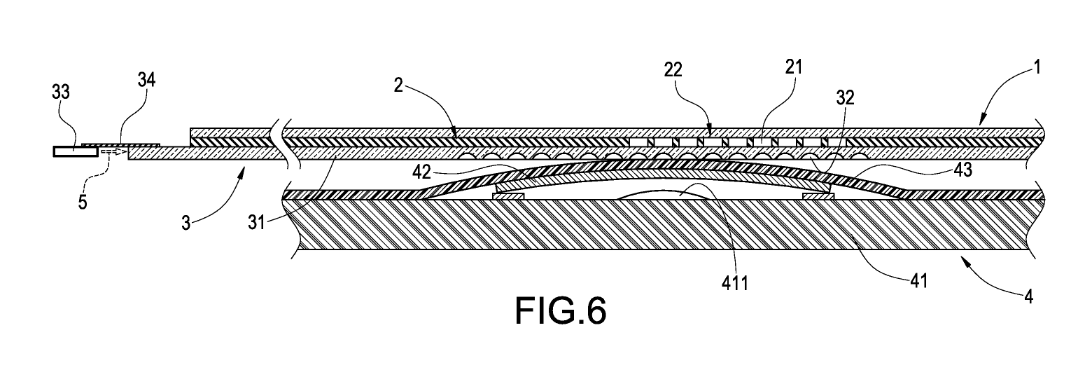

Please refer to FIG. 6, which is an assembled side view showing the keypad panel, the backlight module and another telecommunication module of the present invention. As shown in this figure, another telecommunication module 4 is arranged on one surface of the backlight module. The telecommunication module 4 has a flexible printed circuit board (FPCB) 41. The circuit board 41 is provided thereon with a plurality of contacting points 411. Each contacting point 411 corresponds to a metal dome 42. A film layer 43 is arranged on one surface of the circuit board 41 and the metal dome 42. The metal dome 42 corresponds to the light-guiding microstructures 32 on the light-guiding plate 31.

When the surface of the panel body 1 is pressed by an external force, the surface of the panel body 1 is deformed to press the film layer 43. As a result, the metal dome 42 is deformed and pressed to contact with the contacting point 411, thereby generating a conductive signal output.

When one surface of the panel body 1 is not pressed by an external force, due to the elasticity of the panel body 1 and the metal dome 42, the keypad panel 1 may rise automatically to its original state.

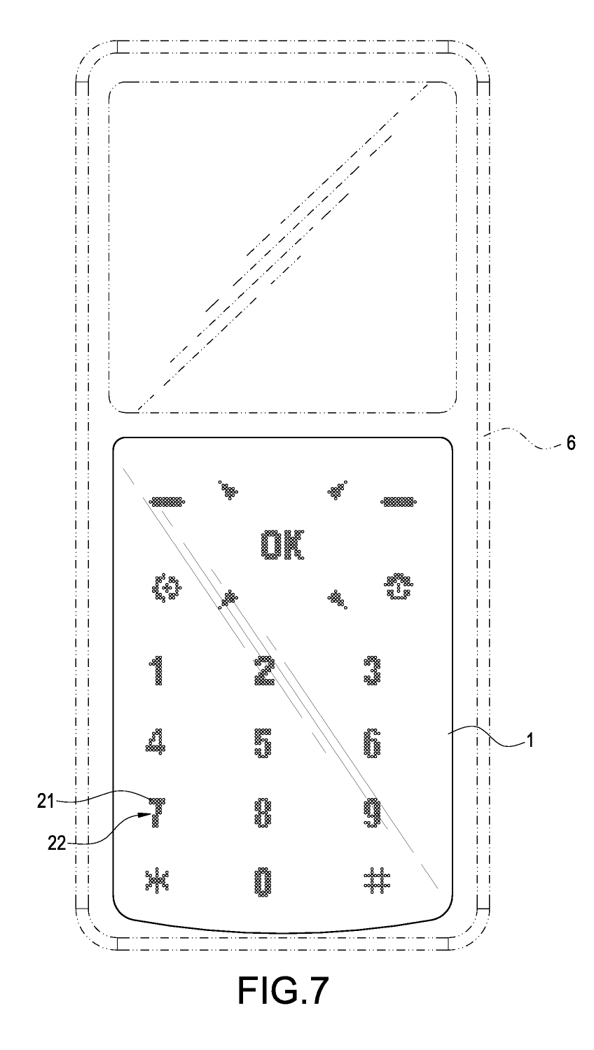

With reference to FIG. 7, it is a schematic view showing the keypad panel of the present invention being used in a mobile phone. As shown in this figure, after the panel body 1 of the present invention is manufactured completely, it can be applied to a mobile phone 6. When the light illuminates the panel body 1, the panel body 1 generates a backlight of a luster, thereby increasing the aesthetic feeling of the mobile phone 6.

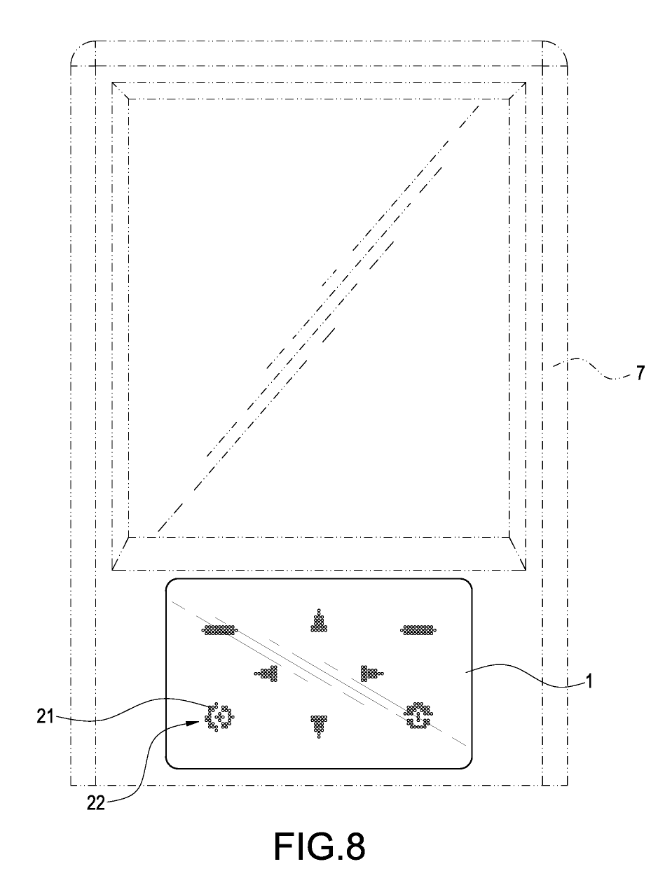

With reference to FIG. 8, it is a schematic view showing the keypad panel of the present invention being used in a personal digital assistant. As shown in this figure, after the panel body 1 of the present invention is manufactured completely, in addition to the mobile phone 6, it can be applied to a personal digital assistant (PDA) 7. When the light illuminates the panel body 1, it generates a backlight of a luster, thereby increasing the aesthetic feeling of the personal digital assistant (PDA) 7.

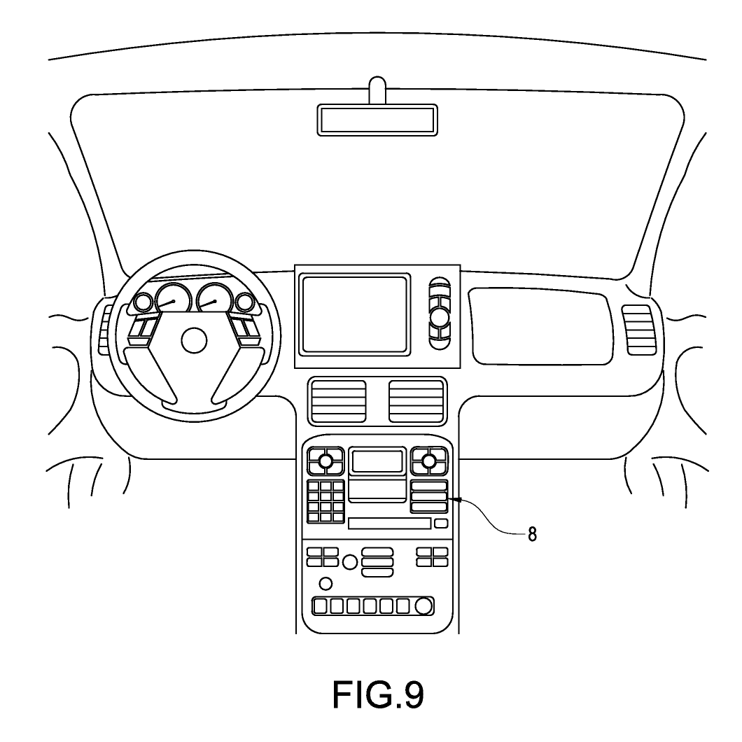

With reference to FIG. 9, it is a schematic view showing the keypad panel of the present invention being used in an automobile stereo panel. As shown in this figure, after the panel body 1 of the present invention is manufactured completely, in addition to the mobile phone 6 and the personal digital assistant (PDA) 7, it can be mounted in an automobile stereo panel 8, thereby controlling the operations of an air conditioning system, audio-video system and satellite navigation system.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A keypad panel assembly having arrays of micropores, the keypad panel assembly being disposed on a surface of an electronic device and comprising:
a panel body;
a shielding layer arranged on one surface of the panel body and having a plurality of micropores thereon, the plurality of micropores being arranged to form patterns; and
a backlight module arranged on one surface of the shielding layer and having a light-guiding plate thereon, the light-guiding plate having thereon a plurality of light-guiding microstructures corresponding to the patterns.

2. The keypad panel assembly having arrays of micropores according to claim 1, wherein the panel body is a plastic thin plate made of a plastic material selected from any one of a PC film or TPU film.

3. The keypad panel assembly having arrays of micropores according to claim 1, wherein the shielding layer is made of inks.

4. The keypad panel assembly having arrays of micropores according to claim 1, wherein the shielding layer is made of any one of Al, Ni, Ti or Ag.

5. The keypad panel assembly having arrays of micropores according to claim 1, wherein the pattern comprises any one of numerals, characters, special symbols (“#”, “*”, “.”) and direction symbols.

6. The keypad panel assembly having arrays of micropores according to claim 1, wherein one end of the light-guiding plate is provided with a set of light-emitting units, a sheet-like shielding unit is arranged above the set of light-emitting units and the light-guiding plate.

7. The keypad panel assembly having arrays of micropores according to claim 6, wherein the set of light-emitting units is constituted of a plurality of light-emitting diodes having the same color.

8. The keypad panel assembly having arrays of micropores according to claim 6, wherein the set of light-emitting units is constituted of a plurality of light-emitting diodes having different colors.

9. The keypad panel assembly having arrays of micropores according to claim 1, wherein the light-guiding microstructures are recessed in one surface of the light-guiding plate.

10. The keypad panel assembly having arrays of micropores according to claim 1, wherein the light-guiding microstructures protrude from one surface of the light-guiding plate.

11. A keypad panel assembly having arrays of micropores, the keypad panel assembly being disposed on a surface of an electronic device and comprising:
a panel body;
a shielding layer arranged on one surface of the panel body and having a plurality of micropores thereon, the plurality of micropores being arranged to form patterns;
a backlight module arranged on one surface of the shielding layer and having a light-guiding plate thereon, the light-guiding plate having thereon a plurality of light-guiding microstructures corresponding to the patterns; and
a telecommunication module arranged on one surface of the backlight module.

12. The keypad panel assembly having arrays of micropores according to claim 11, wherein the panel body is a plastic thin plate made of a plastic material selected from any one of a PC film or TPU film.

13. The keypad panel assembly having arrays of micropores according to claim 11, wherein the shielding layer is made of inks.

14. The keypad panel assembly having arrays of micropores according to claim 11, wherein the shielding layer is made of any one of Al, Ni, Ti or Ag.

15. The keypad panel assembly having arrays of micropores according to claim 11, wherein the pattern comprises any one of numerals, characters, special symbols (“#”, “*”, “.”) and direction symbols.

16. The keypad panel assembly having arrays of micropores according to claim 11, wherein one end of the light-guiding plate is provided with a set of light-emitting units, a sheet-like shielding unit is arranged above the set of light-emitting units and the light-guiding plate.

17. The keypad panel assembly having arrays of micropores according to claim 16, wherein the set of light-emitting units is constituted of a plurality of light-emitting diodes having the same color.

18. The keypad panel assembly having arrays of micropores according to claim 16, wherein the set of light-emitting units is constituted of a plurality of light-emitting diodes having different colors.

19. The keypad panel assembly having arrays of micropores according to claim 11, wherein the light-guiding microstructures are recessed in one surface of the light-guiding plate.

20. The keypad panel assembly having arrays of micropores according to claim 11, wherein the light-guiding microstructures protrude from one surface of the light-guiding plate.

21. The keypad panel assembly having arrays of micropores according to claim 11, wherein the telecommunication module comprises:
a flexible printed circuit board having thereon a plurality of contacting points;
a plurality of metal domes arranged on the circuit board, each metal dome corresponding to each contacting point;
a film layer arranged on one surface of the circuit board and the metal dome; and
a plurality of protrusions arranged on one surface of the film layer, the protrusion corresponding to the light-guiding microstructures of the light-guiding plate.

22. The keypad panel assembly having arrays of micropores according to claim 11, wherein the telecommunication module comprises:
a flexible printed circuit board having thereon a plurality of contacting points;
a plurality of metal domes arranged on the circuit board, each metal dome corresponding to each contacting point; and
a film layer arranged on one surface of the circuit board and the metal dome.
